(19) United States
(12) Patent Application Publication
(10) Pub. No.: US 2008/0066313 A1
(43) Pub. Date: Mar. 20, 2008

(54) Beverage dispenser construction

(75) Inventors: Steve Hubbard, Mason City, IA (US); Russell Johnson, Ventura, IA (US)

Correspondence Address: PYLE & PIONTEK LLC, 221 N. LASALLE STREET, SUITE 2036, CHICAGO, IL, 60601, US

(73) Assignee: IMI Cornelius Inc.

(21) Appl. No.: 11/799,151

(22) Filed: May 1, 2007

Related U.S. Application Data
(60) Provisional application No. 60/796,728, filed on May 2, 2006.

(51) Int. Cl. B32B 5/18

(52) U.S. Cl. 29/897.32; 428/98

(57) ABSTRACT

A sandwich panel is constructed by molding or spraying to provide a foam insulated panel for an ice/beverage dispensing machine. The panel comprises a foam thereon and a hard coating on the foam on the side opposite the panel. The foam could be a urethane with a foaming agent and the hard coating could also be a urethane but without a foaming agent. The panel could be formed by spraying or molding or upon another existing structural member, such as of stainless steel and can be used to enclose and insulate other components such as beverage lines or ice bin.

This is a U.S. Non-Provisional application based on and claiming the filing date and priority of U.S. Provisional Application Ser. No. 60/796,728 filed on May 2, 2006, and relates to an apparatus and method for constructing, use and refurbishment of a beverage/ice dispenser.

### BACKGROUND OF THE INVENTION

Beverage and/or ice dispensing machines (hereinafter jointly referred to as beverage/ice machines) are commonly used in the broad array of establishments providing beverages and food. The beverage/ice dispensing machines are designed to maintain the desired temperature of the dispensed beverage through the use of refrigeration and/or ice and insulation on their components. Foams, such as polyurethane, are often used as insulating products in these machines since they are a relatively inexpensive, can be molded or sprayed and are an effective insulating product. The major components such as ice bins, lines, pipes, hoses etc. are coated with insulating foam to maintain the desired temperature as the beverage and/or ice is routed through the machine to the dispensing point, such as a valve or spigot.

The beverage/ice dispensing machines are typically used by large numbers of customers and or service personal. The heavy usage of these machines results in various beverages and materials being spilled onto the components. The spilled liquids can not be easily removed or extracted from the foam creating an environment for the growth of mold and bacteria. Cleaning is difficult because the foam insulation is easily damaged, scratched and deteriorates when attempted to clean it, such as by rubbing the insulation with wet cloths. The beverage/ice dispensing machines must on occasion then be removed from the establishments, cleaned and refurbished, or rebuilt to extend their operating lives. This process usually involves removing and replacing the old insulation and cleaning and disinfecting the components. This is a costly and inconvenient process due to the current means for insulating components.

Various inventions have been proposed to solve the above problem. One machine integrates many of the major components into one unit which can be removed from the main unit allowing easier cleaning and eliminating the necessity of removing the entire machine from the premises. However, foam insulation will still deteriorate over time from the extensive cleaning and or scouring required to prevent the growth of mold and bacteria.

It would therefore be highly desirable to have an insulated beverage/ice dispenser that provides for maintaining the beverage or ice constituents at the required temperature without more expensive hardware and yet preserve the insulating foam.

### SUMMARY OF THE INVENTION

The present invention provides a foam such as polyurethane with a hard coating, such as a urethane, encasing the foam and the beverage/ice dispensing machine components. The inner polyurethane coating provides the inexpensive insulation. The outer urethane coating provides a hard easy to clean surface that resists the growth of mold and bacteria and provides a nonporous rigid structure so that the two coatings can make up a structural unit of the beverage/ice dispensing machine. The dual coated component units eliminate the need for costly and inconvenient replacement of polyurethane foam insulation that is damaged by use and/or harsh cleaning. While urethane foam and hard coat are preferred, other suitable materials to be used are foams, and epoxies, or plastic hard coat.

### OBJECT OF THE INVENTION

One object of the invention is to provide beverage/ice dispensing machine components with a foam coating such as polyurethane which forms an inner insulation and an outer hard coating thereon such as provided by a urethane, such as Chemthane 7000, to allow the outer surfaces to be easily cleaned, thus resisting the growth of mold and bacteria.

Another object of the invention is to provide for dual coated components to serve as at least a portion of the structural unit of the ice and/or beverage dispensing machine.

Another object of the invention is to reduce the need for or frequency of removal of the ice and/or beverage dispensing machine from its commercial location for cleaning and replacing soiled and damaged foam providing cost savings in the form of reduced machine operation costs and maintenance.

Yet another object of the present invention is to make it less expensive to refurbish or rebuild such beverage/ice machines by making the foamed/hard coated components more reusable and giving them a longer useful life.

Still another object of the present invention is to eliminate one or more pieces used in making a sandwiched construction; foam and hard coating is now used, instead.

Still another object of the present invention is to eliminate one or more of the pieces required in making a sandwiched construction.

### BRIEF DESCRIPTION OF THE DRAWINGS

FIG. 1 is a perspective view of an ice cooled, beverage/ice dispensing machine.

FIG. 2 is a perspective interior view of an ice cooled beverage/ice dispensing structure or tower, showing an ice bin and a plurality of drink dispensing valves.

FIG. 3 is a cut away view of a sandwiched construction of the prior art for an ice bin.

FIGS. 3A is a cut away view of a side of the ice container bin of a sandwiched construction of the present invention of an ice cooled beverage/ice dispensing tower.

FIG. 3B is a cut away view of an alternative construction for the ice container bin of an ice cooled beverage/ice dispenser tower.

FIG. 4 is a front elevational view of an ice cooled beverage/ice dispensing tower showing the beverage dispensing hoses entering the tower and to be connected to the dispensing valves (not shown).

FIG. 5A is an enlarged elevational view of beverage delivery hoses for the dispenser shown in FIGS. 1 and 4.

FIG. 5B is an enlarged elevational view of beverage delivery hoses enclosed in foam insulation with a hard coating on its outer surface.

FIG. 6 is a sectional view taken along the line 6-6 of FIG. 5B of foam insulation shown in FIG. 5B with a hard coating thereon.

### DESCRIPTION OF PREFERRED EMBODIMENTS

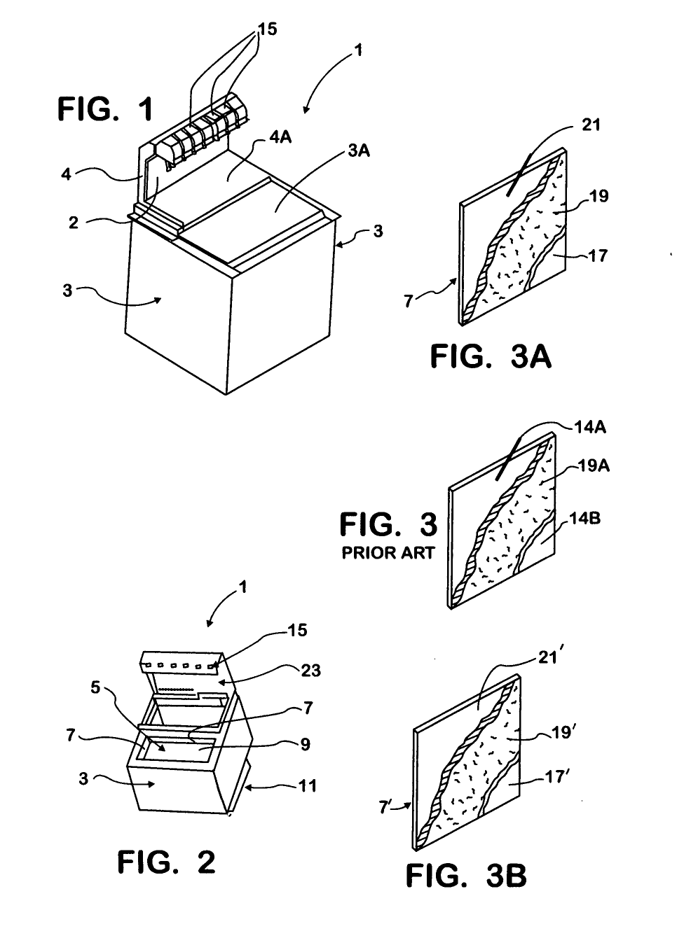

In FIGS. 1 and 2 there is shown a beverage/ice dispensing machine 1 having a top 3A with an ice bin 5 (FIG. 2) there beneath and two of the four exterior sides 3 and a tower portion 4 having a panel wall 2. Mounted on the tower portion 4 are a plurality of beverage dispensing valves 15 which extend over a drip tray 4A.

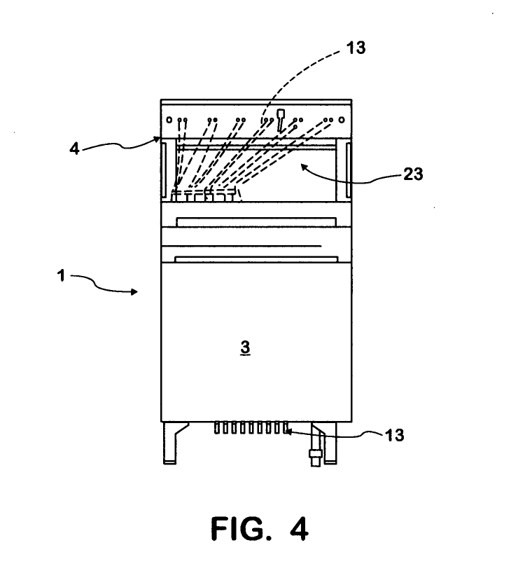

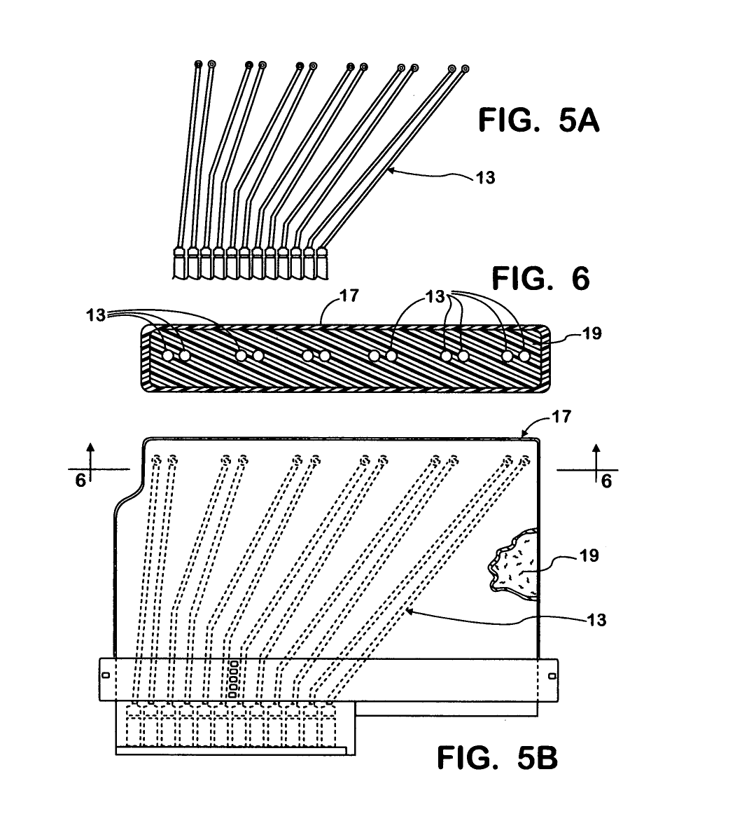

In FIG. 2 there is shown the interior structure of machine or unit 1 including two of the four interior sides 7 and the bottom 9 of the beverage dispensing tower's ice container bin 5. The beverages from a location (not shown) outside the beverage dispensing tower 4 are routed though the refrigeration/ice cooled block or cold plate 11, usually located in the bottom of the ice bin 5, by means of beverage delivery hoses or lines 13 (see FIGS. 4, 5A and B and 6) through the tower 4 to the dispensing point valves or spigots 15. Ice of course is normally loaded on the top of the cold plate 11 and used to cool the beverages, the ice being provided by an ice maker contained in the unit (not shown) or manually loaded into the bin.

FIG. 3 shows the prior art construction typically for an interior of the ice bin and/or bottom, wherein the foam was usually formed between inner and outer parts 14A and 14B made of stainless steel or plastic, such as by injection molding, with the foam insulation 19A being injected there between. While this construction protected the foam, it was expensive and required two other parts, the inner and outer parts 14A and 14B, which in the case of ice bins were bulky and relatively expensive, and if made of plastic, subject to damage before being assembled. Alternatively in the prior art, the foam was sprayed onto the inner panel, usually stainless steel, and then left exposed and unprotected on its exterior.

In FIG. 3A there is shown a typical side 7 of the present invention comprising an inner panel 21, such as stainless steel coated with a foam 19, such as polyurethane, which is then subsequently spray coated with an outer hard coating 17, such as urethane, as for example sold under the brand Chemthane 7000. The foam could be of from 1.00 to 5.00 inches thick, with a thickness of about 1.50 to 3.00 inches preferred, and in this instance is 2.00 avg. inches thick. The hard coat could be from 0.005 to 0.125 inches thick, with a thickness of about 0.015 to 0.060 inches preferred, and in this instance about 0.015 inches. Of course thickness of the foam and hard coating could vary depending upon the function to be preferred and for different components/locations in the machine and/or temperature gradient trying to be maintained by the foam insulation. The foam and outer hard coating may be similar composition to the insulation, with just the aeration or foaming compound not included in the hard coat formulation. Examples of other suitable foams are: flexible polyurethane foams, and rigid sheet foams. Examples of other suitable hard coats are: epoxies, plastics, rubbers, and other polyurethane/polyurea products.

In FIG. 3B there is shown alternatively formed molded or panel of the present invention including polyurethane 19′ foam on a stainless steel part 21′ of the ice bin 5 with a hard coating 17′ on the outside surface of the foam 19′ forming a typical side 7′ of the ice bin 5. It should be understood in this construction the outer shell of hard coat 17′ could be first formed as by spraying the hard coating in a liquid stage into a mold and then the inner stainless steel part 21′ placed therein, but spaced apart, and then the foam 19′ injected there between. The use of a second and/or an outer stainless steel such as 14B or other material, as shown in the prior art, has been eliminated. The hard coating 17 or 17′ replaces such outer coating (14B) at considerably lower cost and ease of manufacture.

In FIG. 4 there is shown the uninsulated beverage dispensing hoses or lines 13 that at their bottoms would be connected at 13A to the cold plate 11. The lines 13 have bottom connectors 13A from which the lines 13 enter the beverage dispensing tower 2 and angularly disperse through the back panel 23 to connect to the plurality of spaced spigot/valve 15.

In FIG. 5A there is shown on a somewhat enlarged scale the beverage dispensing hard lines or hoses 13 of FIG. 4 angled at the back panel to connect with the spigots/valves 15 shown in FIG. 1. In FIG. 5A no foam insulation has yet been applied to the component 13.

In FIG. 5B there is shown enlarged beverage component or dispensing hoses 13 again angled at the back panel to connect to the spaced spigots/valve 15, but now coated with a block of foam such as polyurethane 19, and then the foam 19 further coated with a hard coating such as urethane 17. As noted, if sprayed the foam would be applied first then the hard coat sprayed on. If molded, the order is reversed. A mold is first sprayed with hard coat; then the lines 13 would be located therein and then the foam injected into the mold to cover the component or lines 13 and to lie within the hard outer coating. FIG. 6 shows how the foam 19 insulates the lines or components 13, while the hard coat 17 protects the foam 19.

While the present invention is shown with a beverage ice containing tower, it can be used with other beverage and/or ice dispensing devices. The provision of the hard coating on the insulation of such beverage/ice dispensing machines reduces the cost of manufacture, reduces maintenance costs, presents a better image to the user or store operator, is easier to clean and maintain, and is less costly to refurbish or rebuild. As noted, costly and expensive to form or fabricate sandwich construction (metal (stainless steel) or plastic (injected) foam, (metal (stainless steel)) heretofore used, can be replaced by the less expensive metal (stainless steel), foam, hard coat sandwich construction of the present invention with the foregoing advantages. As noted the present invention metal (stainless steel) foam, hard coat construction can be either spray formed on the metal part or molded in and removed from a mold.

While the described embodiments disclosure certain steps and elements, it should be understood that the present invention could be used for any dispenser for ice alone, beverages alone, be they hot, cold or both, and like herein a dispenser of both ice and beverages. Further, it should be understood the equivalent steps and elements will fall within the scope of the following claims.

What is claimed is:

1. A sandwiched panel construction for an ice/beverage dispensing machine for use with an ice and/or hot or cold beverage, comprising a panel, foam insulation adjacent the panel and a hard coat on the foam on the side opposite the panel.

2. A sandwich panel as in claim 1, wherein said foam is on one side of said panel of said dispensing machine and said hard coat is on the outside of said foam of said dispensing machine.

3. A sandwich panel as in claim 1, wherein said foam is formed of polyurethane.

4. A sandwich panel as in claim 3, wherein said hard coat is formed of polyurethane.

5. A sandwich panel as in claim 4, wherein said panel is made of stainless steel.

6. A sandwich panel as in claim 2, wherein said hard coat is formed of polyurethane.

7. A panel as in claim 1, wherein said foam is sprayed onto said panel.

8. A panel as in claim 7, wherein said hard coat is sprayed onto said foam.

9. A panel as in claim 1, wherein said hard coat is molded in a mold and said foam is injected onto said hard coat formed in said mold.

10. A beverage dispenser with lines for dispensing one or more beverages, said lines being at least partially enclosed in form insulation, and a hard coating formed around said foam to protect the same.

11. A beverage dispenser as in claim 10, wherein said foam is a polyurethane.

12. A beverage dispenser as in claim 11, wherein said hard coat is a polyurethane.

13. A beverage dispenser as in claim 12, wherein said lines are stainless steel.

14. A beverage dispenser as in claim 10, wherein said foam is sprayed on said lines.

15. A dispenser as in claim 14, wherein said hard coat is sprayed on said foam.

16. A dispenser as in claim 10, wherein said hard coat is formed in a mold, said lines are installed in said mold and said foam is injected onto said hard coat to at least partially enclose said lines.

17. A method for constructing a sandwich panel for an ice/beverage dispensing machine for use with an ice and/or hot or cold beverage, comprising providing a panel, locating foam adjacent the panel and locating a hard coating on the foam on the side opposite the panel.

18. A method as in claim 17, comprising the step of molding said panel.

19. A method as in claim 17, comprising the step of spraying the hard coating onto said foam.

20. A method as in claim 17, comprising the step of injecting foam onto said hard coat.

21. A method of sandwich construction for a beverage machine dispensing a hot or cold drink through lines, comprising the steps of locating the lines and covering the lines with foam insulation and covering the foam insulation with hard coat.

22. A method as in claim 22, wherein said construction is formed by molding.

23. A method as in claim 22, wherein said construction is formed by spraying.

24. A method as in claim 22, wherein said hard coat is formed in a mold, said lines are inserted into the hard coat, and foam is injected between said hard coat and lines.

25. A method as in claim 24, wherein said hard coat, lines and foam are then removed from said mold for use.
